(19) United States
(12) Patent Application Publication
(10) Pub. No.: US 2020/0265644 A1
(43) Pub. Date: Aug. 20, 2020

(54) METHOD AND SYSTEM FOR GENERATING MERGED REALITY IMAGES

(71) Applicant: LIMITED LIABILITY COMPANY "TRANSINZHKOM", Moscow (RU)

(72) Inventor: Ilnur Zyamilevich KHARISOV, Respublika Tatarstan (RU)

(21) Appl. No.: 16/484,578

(22) PCT Filed: Sep. 12, 2018
(86) PCT No.: PCT/RU2018/000595

§ 371 Date: Aug. 8, 2019

(51) Int. Cl. G06T 19/00; G06F 3/01; H04W 4/021

(52) U.S. Cl. CPC G06T 19/006; G01S 13/86; H04W 4/021; G06F 3/012

(57) ABSTRACT

The invention relates to the merged reality visualization means. The technical result is to provide an accurate image of the merged reality. The visualization device location data is determined by signals emitted from ultra-wideband transmitters disposed in known locations. The visualization device orientation data is determined via the inertial navigation system of the visualization device. The camera of a visualization device is used to receive data of the user's real surrounding environment image; data on a geo-referenced virtual reality object to be displayed to the user is loaded into the processing unit. Using the processing unit, data on the geo-referenced virtual reality object and real surrounding environment image data are merged using the visualization device location and orientation data in such a way as to place the data on the virtual reality object and real surrounding environment image in a single spatial coordinate system, thus obtaining the merged reality images. The merged reality images are displayed to the user via a visualization device. 2 independent and 6 dependent claims, 2 figures.

The field of technology to which the invention relates.

The invention relates to the visualization of the merged reality, in particular, to the visualization of construction projects according to the drawings at the site of their future construction.

### STATE OF THE ART

Solutions intended to provide the user with virtual reality images are used in various fields of human activity.

There are virtual reality solutions, in which only images from the computer's memory are conveyed to the user via VR glasses or a VR helmet.

There are augmented reality solutions, in which the user sees additional images superimposed on real-world images without geo-reference of real-world objects.

There are solutions in the field of merged reality, in which virtual reality images are linked to the real-world geographical coordinates, which further improves the realism of virtual reality images and provides more opportunities for interaction therewith.

A solution is known (US2014210947 (A1), published on Jul. 31, 2014), which describes the process of augmented reality generation using coordinate geometry. The embodiments of this invention comprise a process, a system and a mobile device that include augmented reality technology in a land-base survey, 3D laser scanning and digital modeling processes. When using augmented reality technology, a mobile device can display an augmented reality image that represents the real view of a physical structure in the real environment and a three-dimensional digital model of an unbuilt design element superimposed over the physical structure at its intended construction site. In one embodiment, the marker can be placed within the set selection of coordinates on or around the place of interest defined by means of the land surveying equipment in such a way that the three-dimensional digital model of the unbuilt design element could be visualized in geometrically correct orientation relative to the physical structure. The embodiments of this solution may also apply to a reduced three-dimensional printed object representing the physical structure if a visit to the project site is not possible.

However, this solution assumes that for generating an image markers should be disposed in the place of interest in order to orient the device that generates an augmented image in space.

A solution is known (US2014270477 (A1), published on Sep. 18, 2014), which describes the systems and methods of displaying the three-dimensional model from photogrammetric scanning. One of the embodiments offers a computer-implemented way to display the three-dimensional (3D) model from photogrammetric scanning. The object image and scanning marker can be obtained at the first location. The relationship between the object and scanning marker images at the first location can be determined. The geometric property of an object can be determined based on the relationship between the object image and the scanning marker image. The 3D model of the object can be generated based on a specific geometric property of the object. The 3D model of the object can be displayed for scaling in the augmented reality environment at the second location based on the scanning marker at the second location.

However, this solution assumes that for generating an image markers should be disposed in the place of interest in order to generate an augmented image.

A solution is known (US2016104323 (A1), published on Apr. 14, 2016), which describes the image display device and the method to display the image. According to one embodiment, the image display device includes a data acquisition and a display processing module. The data acquisition module is configured to receive the accepted image, which is captured by the camera and which includes an optical recognition code that represents the identification information, by generating a set of elements in the form of a line. The display processing module is configured to superimpose and display the image of a three-dimensional object corresponding to the identification information on the captured image. The orientation of the 3D object image superimposed and displayed on the captured image is determined by the orientation of the optical recognition code on the captured image and the camera tilt.

However, it is necessary in this solution to place the identification information for building an image.

### SUMMARY OF THE INVENTION

One aspect of the invention discloses a method to generate the merged reality images, the method comprising:

determining visualization device location data based on signals from ultra-wideband transmitters disposed in known locations;

determining visualization device data via a visualization device inertial navigation system;

acquiring via a visualization device camera, user's real surrounding image data;

loading into a processing unit data on a geo-referenced virtual reality object to be displayed to the user;

merging, by means of the processing unit, the geo-referenced virtual reality object data with the real surrounding image data, using the visualization device location and orientation data in such a way as to place the virtual reality object data and the real surrounding image data into a single spatial coordinate system, thus producing merged reality images;

displaying the merged reality images to the user via the visualization device.

The additional aspects disclose that the visualization device comprises virtual reality glasses or a helmet; the visualization device camera is a stereoscopic camera; the processing unit is one of: a portable personal computer, a mobile phone, an application-specific integrated circuit, a processor, a controller; the virtual reality object to be displayed to the user is at least one of: a project under construction, a museum, a zoological garden, or an amusement park; the visualization device location data is determined additionally via the inertial navigation system; if the intensity of signals emitted from ultra-wideband transmitters is higher than the specified intensity threshold, the location will be determined based on signals from ultra-wideband transmitters; if the intensity is lower than the specified intensity threshold, the location will be determined via the inertial navigation system; the visualization device location data is determined additionally by the inertial navigation system based on gyroscopes and accelerometers, whereby the intensity threshold for RF signals is decreasing over time.

The other aspect of the invention discloses a system to generate merged reality images, comprising:
at least three transmitters located at predetermined real space locations and capable of transmitting RF signals;
a visualization device capable of providing the user with merged reality images, wherein the visualization device comprises

a receiver of transmitter signals capable of receiving RF signals from at least three transmitters and by the trilateration, or triangulation method, or determining its location in real space in a similar way,

a camera capable of receiving the real surrounding image data,

an inertial navigation system capable of receiving the visualization device orientation data;

a display unit capable of providing the user with merged reality images;

a processing unit functionally related to the memory unit, display unit, camera, signal receiver;
a memory unit capable of storing data on a geo-referenced virtual reality object to be displayed to the user;

wherein the processing unit is capable of receiving real surrounding image data, data on a geo-referenced virtual reality object and merge data on a virtual reality object with real environment image data using visualization device location and orientation data in such a way as to place data on a virtual reality object and real environment image data into a single spatial coordinate system, thus obtaining the merged reality images, and capable of providing merged reality data to the visualization device display unit.

The main task to be solved by the claimed invention is an exact generation of merged reality images based on the display device coordinates determined, orientation of the display device, virtual object data stored in memory, surrounding environment images obtained from the camera.

The essence of invention is that the display unit determines its location using ultra-widebrand transmitters disposed in known locations in real space, determines its orientation in real space using the inertial navigation system, transmits this data to a processing unit, which, based on the location and orientation data, merges images of virtual objects geo-referenced to the real space with the real space images, transmits the merged images to the display device to provide the user with the merged reality images.

The technical result achieved by the solution is that it provides a qualitative generation of merged reality images, in which the real space images are precisely merged with images of virtual objects referenced to the real space geographical coordinates.

### BRIEF DESCRIPTION OF DRAWINGS

FIG. 1 shows the user's location positioning diagram.

FIG. 2 shows a block diagram of the system to generate the merged reality images.

### Embodiment of Invention

When drawing merged reality images, it is necessary to position the user's location by positioning the augmented reality helmet, which he wears.

Location of the augmented reality helmet can be determined via GPS, however accuracy can be in this case appr. 6 to 8 meters, which is not acceptable for most applications.

The general drawback of using any radio-navigation system is that under certain conditions the signal may not reach the receiver or may come with significant distortions or delays. For example, it is almost impossible to determine your exact location in the depth of the apartment inside the reinforced concrete building, in the basement or in the tunnel, even if you use professional geodetic receivers. Since the GPS operating frequency is in the decimeter range of the radio waves, the level of signal from satellites may seriously drop under dense foliage of trees or due to very high cloudiness. Normal reception of GPS signals can be affected by interference from many ground radio sources as well as magnetic storms.

In addition to GPS-based methods, there are a number of position location methods which are most suitable for use inside rooms, some of which are presented below:

Positioning based on cellular networks—the accuracy leaves much to be desired even in areas with high base station density.

Positioning using inertial systems that use a human motion model: if we know where we were, in which direction and how fast we moved, we can calculate where we ended up after a while. Now this is achieved with the help of gyroscopes, accelerometers, a Hall sensor or other suitable means.

Positioning using optical systems based on room pre-scanning and afterwards you can determine the location using a picture, e.g. a ceiling from a smartphone's front camera.

Magnetometer-based positioning—use your smartphone's compass to determine your location by magnetic field. The solution requires pre-calibration indoors and is highly susceptible to metal and magnets.

Positioning by trilateration based on Wi-Fi/Bluetooth transmitters. Common equipment, both for infrastructure and positioning, is used for its implementation. It is also possible to use already deployed Wi-Fi/Bluetooth networks.

Radio map or “digital footprints” of Wi-Fi/Bluetooth signals—the location is calculated by comparing real-time measured signal strength from surrounding Wi-Fi/BLE points with pre-defined values linked to the room map.

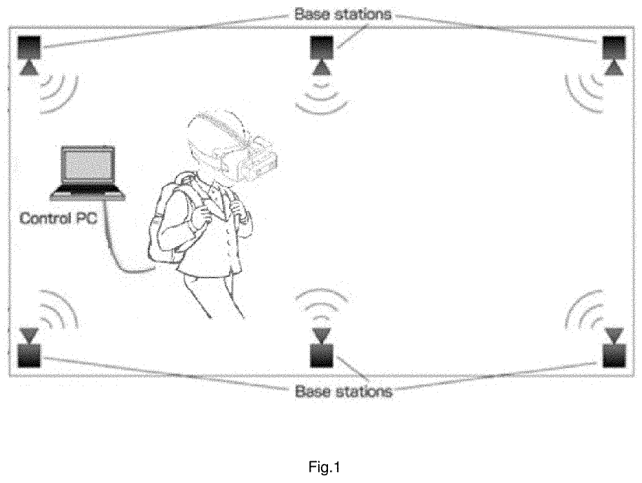

In order to improve the positioning accuracy, it was proposed to place stations transmitting RF signals in real space, where it is supposed to generate merged reality images (see FIG. 1). Using the RF signals of these stations located in coordinates known beforehand, it is possible to determine the location of the receiver with high accuracy using the trilateration method. To implement this approach, at least three transmitters are required, the signal from which is steadily received by the receiver.

The proposed method uses a radar system based on ultra-wideband signals to determine the exact user's location in real space as well as an inertial navigation system to determine the user's orientation (indoor positioning system). As a result of the use of these two systems it is possible to receive the user's real space location and orientation data that enables to place geo-referenced virtual reality objects with the minimum error which is sufficient for the latter to be used as a reference point during execution of e.g. construction works.

The embodiments, which combine the positioning capabilities of different methods, are also discussed below. Such solutions provide acceptable quality for a precise merging of real-world and virtual reality images.

In the proposed solution, the hardware and software to implement positioning functionality is installed in the virtual reality helmet (or glasses), which also comprises at least one camera (preferably a stereoscopic camera) to capture images of the real world around the user who wears the virtual reality helmet.

In general, positioning hardware and software is common and well known in the state-of-the-art; the features that distinguish it from known implementations will be described separately. On the whole, the virtual reality helmet is capable of determining its location via the GPS positioning unit and/or indoor positioning unit, with the features that enable receiving images from the camera, transmitting all data to the processing unit, providing processed data (merged reality data) to the user.

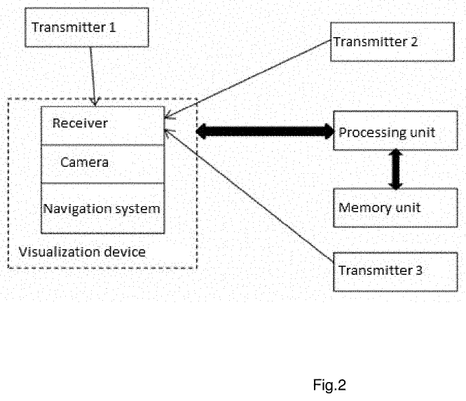

FIG. 2 shows a system to generate merged reality images, which comprises at least three RF signal transmitters, a processing unit, a memory unit, a visualization device which comprises a RF signal receiver, a camera, a navigation system.

The VR helmet transmits its location, orientation and camera data to the processing unit to generate merged reality data by the processing unit through merging of real-world data from the camera and geo-referenced virtual object data from the memory.

The processing unit can be a server, computer, laptop or any other means, whose functionality is capable of receiving data from the VR helmet, process it, merge with the stored VR images and provide it to the user for review through the display of the VR helmet, including a portable personal computer, tablet, mobile phone, an application-specific integrated circuit, processor, controller. In some embodiments, the processing unit can be designed as a single unit with the helmet block or can be integrated into the helmet.

The processing unit is capable of reading data on visualized objects from the memory unit, in a preferable embodiment the data on construction project which can be presented in CAD format (automatic design system). These data are geo-referenced, that is why the processing unit needs to obtain user location data in order to accurately merge the real-world data transmitted from the camera with the VR data stored in the memory. The more precisely the user's location and orientation is determined, the more accurately the data will be merged with each other.

The memory unit can be designed either as an internal or external unit relative to the processing unit. The processing unit itself can be built into the virtual reality helmet, or it can be a separate unit that can be connected to the virtual reality helmet with a communication option.

The user observing the merged reality can vividly see the future structure at its real location, walk along the site which is still planned to be built or is already partially under construction, and watch it from different angles. Such a facility may be e.g. a museum or a building that is only a museum in virtual reality. It can also be an amusement park, either an outdoor or indoor.

The user may also make changes in virtual reality objects; for this purpose, markers are installed on the user's hand which are read out by the camera so that the user is given a graphic menu with may be used to manage a displayed reality, for example, a building model. It is also possible to organize a virtual meeting when images of two users are transmitted to their VR helmets and it is possible to communicate not only with audio, but also with video images of the conversation partner.

In one embodiment, the system for the generation of merged reality images can be functionally divided into two functional parts:

1. Wearable part.

2. Server part.

The wearable part comprises VR glasses (helmet) and a portable computer.

The server part consists of a server for processing and storage of data on a construction project.

The wearable part enables the user to get access to the 3D-model of a building merged with the real image which improves utilization efficiency of all available BIM technology (building information modelling) visual capabilities: viewing and changing the project parameters “on the go”, merging the 3D-model with a real existing embodiment.

The server part preferably represents a platform for cloud calculations by means of a mathematical algorithm that compares the real-world image with the image received from the standard 3D-model of the object. To generate a reference 3D model of an object, the algorithm collects data from different sources: technical documentations (drawings and specifications), estimates, etc.

The result of the mathematical algorithm is merging of data obtained in one image with the real-view image. Merging can be implemented both in the wearable part and the server part, which does not relate to the essence of the claimed solution. In this case, the server part can store e.g. the data on virtual objects and only transfers it to the wearable part for subsequent processing.

In one of the embodiments, the virtual reality helmet tracks its location, using either signals from the base stations' RF transmitters, or data from the indoor-positioning system.

If located in open space without any obstacles to the transmitter signals, the positioning accuracy on their basis will be high enough. However, when located indoors, the accuracy deteriorates, which may result in distorted display of merged reality. In order to reduce such distortions, it was proposed to evaluate the positioning accuracy using RF signals by measuring their intensity: if the intensity of RF signals (one or medium) is below a certain threshold value, the location is determined by using an indoor positioning system.

Once the intensity of the RF signals exceeds the threshold value, the location will be again determined by the RF signals.

If inertial systems with the human motion model are used, whereby motions are detected by gyroscopes and accelerometers, there will be an error accumulation effect: the longer the location is determined by this system, the greater the error. Therefore, in the embodiment, where the location is determined based on the above inertial system and a positioning system based on RF from base stations, the intensity threshold for RF signals will decrease over time to neutralize the error accumulation effect.

One embodiment implies a threshold for the positioning duration using the inertial system: once this threshold is exceeded, the positioning using the inertial system will be considered inaccurate. So, when the threshold of RF signal intensity or threshold of positioning duration using the inertial system is exceeded, the location will be determined based on RF signals, otherwise the location will be determined via the inertial system.

In one of the embodiments, when the threshold of the positioning duration via the inertial system is exceeded, the location is determined jointly by the inertial system and the positioning system using RF signals, whereby the location determined by the two systems is then averaged.

The embodiments are not limited to those described herein, the technician will also find other embodiments that fall within the essence and scope of this invention, based on information set out in the description and knowledge of the state of the art.

The elements referred to in the singular do not exclude the plurality of the elements, unless specifically stated otherwise.

The functional connection of elements shall mean a connection that provides correct interaction between these elements with each other and the implementation of this or another element functionality. Specific examples of functional connection can be a communication with an data exchange feature, a communication with the ability to transmit electrical current, a communication with the ability to transmit mechanical motion, a communication with the ability to transmit light, sound, electromagnetic or mechanical vibrations, etc. The specific type of functional connection is determined by the nature of interaction of the above-mentioned elements and, unless otherwise specified, is provided by widely known means, using common technical principles.

The methods disclosed here contain one or more steps or actions used to achieve the described method. The steps and/or actions of the method can replace each other without going beyond the scope of the claims. In other words, unless a specific order of steps or actions is defined, the order and/or use of the particular steps and/or actions may change without going beyond the scope of the claims.

The claim does not specify the software and hardware used to implement the units on the drawings, but a skilled technician should understand that the essence of the invention is not limited to a specific software or hardware implementation, and therefore any software and hardware known in the state of art may be used to implement the invention. So hardware can be implemented in one or several specialized integrated circuits, digital signal processors, digital signal processing devices, programmable logic devices, user-programmable ASICs, processors, controllers, microcontrollers, microprocessors, electronic devices, other electronic modules, capable of performing the functions described herein, a computer or a combination of the above.

Although not specifically mentioned, it is clear that when it comes to storing data, software, etc., availability of machine-readable media is assumed. Examples of machine-readable media include a permanent storage device, a RAM, a register, a cache memory, semiconductor storage devices, magnetic media such as internal hard disks and removable disks, magneto-optical media and optical media such as CD-ROM disks and digital universal disks (DVDs) as well as any other data media recognized in the state of art.

Although the examples of embodiment have been described and shown in all details in the accompanying drawings, you should keep in mind that such embodiments are exemplary only and are not intended to limit the broader invention and that this invention should not be limited to the specific layouts and structures shown and described since a number of other modifications may be obvious to the skilled experts in the particular field.

The features referred to in the various dependent claims as well as implementations disclosed in different parts of the description, may be combined with the achievement of useful effects, even if the possibility of such combination is not explicitly disclosed.

1. A method for generating merged reality images, the method comprising:
determining visualization device location data based on signals from ultra-wideband transmitters disposed in known locations;
determining visualization device data via a visualization device inertial navigation system;
acquiring, via a visualization device camera, user's real surrounding image data;
loading into a processing unit data on a geo-referenced virtual reality object to be displayed to the user;
merging, by means of the processing unit, the geo-referenced virtual reality object data with the real surrounding image data, using the visualization device location and orientation data in such a way as to place the virtual reality object data and the real surrounding image data into a single spatial coordinate system, thus producing merged reality images;
displaying the merged reality images to the user via the visualization device.

2. The method according to claim 1, wherein the visualization device comprises virtual reality glasses or a helmet.

3. The method according to claim 1, wherein the visualization device camera is a stereoscopic camera.

4. The method according to claim 1, wherein the processing unit is one of: a portable personal computer, a mobile phone, an application-specific integrated circuit, a processor, or a controller.

5. The method according to claim 1, wherein the virtual reality object to be displayed to the user is at least one of: a project under construction, a museum, a zoological garden, or an amusement park

6. The method according to claim 1, wherein the visualization device location data is determined additionally via the inertial navigation system. Thereby, if the intensity of signals emitted from ultra-wideband transmitters is higher than the specified threshold of intensity, the location will be determined by signals from ultra-wideband transmitters, and if the intensity is lower than the specified threshold of intensity, the location will be determined via the inertial navigation system.

7. The method according to claim 6, wherein the visualization device location data is determined additionally via the inertial navigation system based on gyroscopes and accelerometers, whereby the intensity threshold for RF signals is decreasing over time.

8. A system to generate merged reality images, comprising:
at least three transmitters disposed at predetermined real space locations and capable of transmitting RF signals;
a visualization device capable of providing the user with merged reality images, whereby the visualization device comprises
a receiver of transmitter signals capable of receiving RF signals from at least three transmitters and positioning its location in real space by trilateration,
a camera capable of receiving real surrounding environment image data,
an inertial navigation system capable of receiving visualization device orientation data;
a display unit capable of providing the user with merged reality images;
a processing unit connected with the memory unit, display unit, camera, signal receiver;
a memory unit capable of storing data on a geo-referenced virtual reality object to be displayed to the user;
the processing unit is designed to receive real surrounding environment image data, data on a geo-referenced virtual reality object and merge data on a virtual reality object and real surrounding environment image data using visualization device location and orientation data in such a way as to place data on a virtual reality object and real surrounding environment image data into one system of spatial coordinates, thus obtaining the augmented reality images, and capable of providing merged reality data to the display unit of the visualization device.
